(19) United States
(12) Patent Application Publication
(10) Pub. No.: US 2011/0317967 A1
(43) Pub. Date: Dec. 29, 2011

(54) SPLICED CONNECTION BETWEEN TWO OPTICAL FIBERS AND METHOD FOR PRODUCING A SPLICED CONNECTION OF THIS TYPE

(75) Inventors: Malte Kumkar, Weimar (DE); Marcin Michal Kozak, Teltow (DE); Ulrich Grusemann, Gauting (DE)

(73) Assignee: JT OPTICAL ENGINE GMBH + CO. KG, Jena (DE)

(21) Appl. No.: 13/141,913

(22) PCT Filed: Dec. 18, 2009
(86) PCT No.: PCT/DE09/01787

§ 371 Date: Sep. 9, 2011

(30) Foreign Application Priority Data
Dec. 23, 2008 (DE) 102008062847.6

(51) Int. Cl. G02B 6/255

(52) U.S. Cl. 385/98; 385/99

(57) ABSTRACT

The invention in certain embodiments relates to a spliced connection between first and second optical fibres, each of which has a fibre core and fibre cladding resting against said core. In said connection, the fibre cladding of at least one of the two fibres is completely removed in a connection region that extends for a predetermined length from the spliced end of the respective fibre in the longitudinal direction of the fibre and said connection is provided with a support sleeve, in which the spliced ends of the two fibres are located and which extends at least along the entire connection region of the first fibre and beyond, over the fibre cladding of the first fibre. The section of the support sleeve that extends over the fibre cladding of the first fibre does not rest against the fibre cladding of the first fibre and said sleeve is mechanically connected to the fibre core of the first fibre in the connection region of said first fibre, either directly or by means of an intermediate sleeve.

The present invention relates to a spliced joint between two optical fibres, which each have a fibre core and a fibre sheath that lies against the latter. Further, the present invention relates to a method for producing such a spliced joint.

When the fibres are designed to guide high optical power with high beam quality, there exists the difficulty of the increased sensitivity to mismatches and bends, which can result, disadvantageously, for example, in the occurrence of increased losses for the light guided in the fibre core and/or in an unwanted coupling occurring between differing modes guided in the fibre core.

Further, the high energy input that occurs, in the region of the ends to be spliced, during the splicing operation can result in an alteration of the guiding properties of the fibres, such that, for example, an unwanted coupling-out of some of the guided radiation occurs in this region as a result. This can result in an inadmissibly high thermal loading of the fibre sheath, which, frequently, is realized as a polymer protective sheath. In the case of double-core fibres, in which the fibre core has an inner signal core and a pump core surrounding the latter, the radiation coupled out of the inner signal core can propagate over long distances in the pump core. In order to attain a desired beam quality, however, it is frequently necessary that only radiation from the inner signal core emerges at the end of the entire fibre run, such that the radiation guided in the pump core impairs the beam quality.

Proceeding therefrom, it is an object of the invention to provide an improved spliced joint between two optical fibres. Further, a corresponding method for producing such a spliced joint is to be provided.

The object is achieved, according to the invention, by a spliced joint between two optical fibres, which each have a fibre core and a fibre sheath that lies against the latter, in which, in the case of at least a first of the two fibres, the fibre sheath is completely removed in a connection region that extends along a predetermined length from the spliced end of the respective fibre, in the longitudinal direction of the fibre, and in which there is provided a support sleeve, in which the spliced ends of the two fibres are disposed and which extends at least along the entire connection region of the first fibre and therebeyond, over the fibre sheath of the first fibre, wherein the portion of the support sleeve that extends over the fibre sheath of the first fibre does not lie against the fibre sheath of the first fibre and, in the connection region of the first fibre, the support sleeve is mechanically connected to the fibre core of the first fibre, either directly or via an intermediate sleeve.

The mechanical contact between the support sleeve and the fibre core of the first fibre enables a mechanical stabilization of the spliced joint to be achieved, such that an unwanted bending of the fibre core of the first fibre is prevented. Further, the support sleeve, since it extends over the sheath of the first fibre, can also protect the spliced joint against contamination. Furthermore, in the case of the spliced joint according to the invention, the fibre sheath does not undergo thermal loading in the realization of the spliced joint, since the support sleeve does not lie against the fibre sheath itself and also does not have to be connected to the latter.

The sheath of the optical fibre refers here, in particular, to the part of the fibre that cannot be subjected to thermal loading and that is therefore removed from the fibre before the fibre ends are spliced. In the meaning of the invention, therefore, the sheath is, in particular, the protective sheath of the optical fibre. Here, the core of the fibre is, in particular, the remaining part of the fibre. The fibre core serves, in particular, to guide light, wherein it can be constructed in differing ways, in order to achieve the sought guiding function for the light. It typically comprises the signal-guiding core (e.g. of glass material) and the sheath, of glass material, that surrounds the latter and that ensures the guiding of the light in the signal core. In the case of double-core fibres, the sheath in this case constitutes, for example, the so-called pump core, in which so-called pump light is guided in this sheath. Thus, here, the fibre core refers, in particular, to the part of the optical fibre that remains when the protective sheath is removed, wherein this fibre core is typically composed of glass materials having differing dopings and also, if appropriate, having included cavities.

In the case of a single-core fibre, the core of the single-core fibre and the sheath of the single-core fibre are here the fibre core in the meaning of the invention, and the sheath is the protective sheath of the single-core fibre in the meaning of the invention.

In the case of a double-core fibre, for example, the core and the so-called cladding constitute the core in the meaning of the invention, and the sheath of the double-core fibre is the sheath in the meaning of the invention. Clearly, it can be the case that the cladding is also to be removed. In this case, the cladding and sheath of the double-core fibre constitute the sheath in the meaning of the invention, and the core of the double-core fibre is the core in the meaning of the invention. The same applies to fibres having, for example, a triple or quadruple core, or to other fibres having at least one core and one sheath.

In particular, the fibre core refers to the part of the fibre that is made, for example, of glass and normally guides the light, or the electromagnetic radiation. The electromagnetic radiation in this case is, in particular, electromagnetic radiation of the visible spectrum (e.g. 380 nm to 780 nm) and of the adjoining infrared electromagnetic spectrum (780 nm to 2500 nm).

The support sleeve is preferably realized as a stiff, or rigid, support sleeve that provides the desired protection against bends and kinks.

The protective sleeve can be produced from the same material as the fibre core. In particular, the protective sleeve can be produced from quartz glass.

The mechanical connection between the support sleeve and the intermediate sleeve or fibre core is, in particular, a form-locking and/or material-bonding connection. The same applies to the connection of the intermediate sleeve to the fibre core.

The mechanical connection can be produced, in particular, through a local input of heat. In particular, laser radiation can be used for this purpose, such that the support sleeve, or the intermediate sleeve, is fused onto the fibre core.

In the case of the spliced joint according to the invention, it is possible for the portion of the support sleeve that extends over the fibre sheath of the first fibre, apart from a possibly provided end-face sealing, not to be mechanically connected to the fibre sheath. This achieves the advantage that no input of heat is required in this portion, with the result that thermal damage to the fibre sheath can be prevented. The end-face sealing can be produced, in particular, from the same material as the material of the fibre sheath (e.g. polymer material).

In the region in which the mechanical connection is present, the support sleeve can have an inner diameter that is less than the inner diameter of the portion that extends over the fibre sheath of the first fibre. The support sleeve can thus have a changing inner diameter. In particular, the wall thickness of the support sleeve is constant. However, it can also vary along its longitudinal direction.

In the case of the spliced joint according to the invention, the fibre sheath can be completely removed in the respective connection region in the case of both fibres, the support sleeve can extend along the entire connection region of the second fibre and therebeyond, over the fibre sheath of the second fibre, wherein the portion of the support sleeve that extends over the fibre sheath of the second fibre does not lie against the fibre sheath of the second fibre. An excellent mechanical stability of the spliced joint is ensured by means of such a support sleeve. Further, the spliced joint can be well protected against contamination.

In the connection region of the second fibre, the support sleeve can be mechanically connected to the fibre core of the second fibre, either directly or via an intermediate sleeve. In particular, it is possible for mechanical connections to be present both in the connection region of the first fibre and in the connection region of the second fibre. In particular, the mechanical connection can extend over the spliced ends.

Advantageously, it is possible for the portion of the support sleeve that extends over the fibre sheath of the second fibre, apart from a possibly provided end-face sealing, not to be mechanically connected to the fibre sheath.

In the case of the support sleeve being directly mechanically connected to the fibre core, the refractive index of the support sleeve can be selected such that light guided in the fibre core can be coupled out, into the support sleeve, via the direct connection. For this purpose, the refractive index of the support sleeve can be constant, or can vary spatially. What is essential in this case is that the light guided in the fibre core can at least partially couple over into the support sleeve.

In the case of the support sleeve being mechanically connected to the fibre core via the intermediate sleeve, the refractive indices (including any refractive index variations) of the support sleeve and intermediate sleeve can be selected such that light guided in the fibre core is coupled out, into the support sleeve, via the intermediate sleeve.

In particular, the support sleeve can be realized as a volume scatterer. The material of the support sleeve thus has a highly scattering effect upon the coupled-in light, since, for example, scattering particles are contained in the material of the support sleeve. As a result, the coupled-out light can be emitted into the environment over a greater spatial region, such that the thermal load per area is reduced.

Additionally or alternatively, the support sleeve can be realized as a surface scatterer. This can be realized, for example, in that the surface is roughened.

The intermediate sleeve(s), likewise, can be realized as volume and/or surface scatterers.

Clearly, the refractive index (indices) can also be selected such that coupling-out of light from the fibre core is suppressed insofar as possible.

The support sleeve can be realized, in particular, as a single-piece support sleeve. The at least one intermediate sleeve can also be realized as a single piece in each case. Further, the at least one intermediate sleeve can be produced from the same material as the support sleeve.

In the case of the spliced joint according to the invention, no further connection means (such as, for example, cured lacquer or resins, heat-shrink tubings, etc.), apart from the possibly provided intermediate sleeve, or intermediate sleeves, are disposed between the support sleeve and the exposed fibre core.

Further provided is a method for producing a spliced joint between two optical fibres, which each have a fibre core and a fibre sheath that lies against the latter, in which, in the case of at least a first of the two fibres, the fibre sheath is completely removed in a connection region that extends along a predetermined length from the end of the respective fibre that is to be spliced, in the longitudinal direction of the fibre, a support sleeve is pushed over one of the two fibres, the two ends of the fibres that are to be spliced are aligned to each other and spliced to each other, the support sleeve is then pushed over the spliced ends such that the spliced ends of the two fibres are disposed in the support sleeve, and the support sleeve extends at least along the entire connection region of the first fibre and therebeyond, over the fibre sheath of the first fibre, without the portion of the support sleeve that extends over the fibre sheath of the first fibre lying against the fibre sheath of the first fibre and, in the connection region of the first fibre, the support sleeve is mechanically connected to the fibre core of the first fibre, either directly or via an intermediate sleeve.

The method according to the invention makes it possible to produce a spliced joint in which the spliced fibres in the region of the spliced ends are protected against bending and kinking, and against contamination.

The mechanical connection between the support sleeve and the intermediate sleeve or fibre core can be realized as a form-locking and/or material-bonding connection. In particular, the connecting can be realized by means of input of heat. In particular, a laser can be used for this purpose.

In the case of the method, it is possible for the portion of the support sleeve that extends over the fibre sheath of the first fibre, apart from a possibly effected end-face sealing, not to be mechanically connected to the fibre sheath. Consequently, the fibre sheath is not subjected to excessive thermal loading.

Further, the fibre sheath can be completely removed in the respective connection region in the case of both fibres, the support sleeve can be pushed over the spliced ends such that it extends along the entire connection region of the second fibre and therebeyond, over the fibre sheath of the second fibre, without the portion of the support sleeve that extends over the fibre sheath of the second fibre lying against the fibre sheath of the second fibre. In particular, in the connection region of the second fibre, the support sleeve can be mechanically connected to the fibre core of the second fibre, either directly or via an intermediate sleeve. It is also possible for the portion of the support sleeve that extends over the fibre sheath of the second fibre, apart from a possibly provided end-face sealing, not to be mechanically connected to the fibre sheath.

These steps make it possible to produce a spliced joint having the desired properties.

Further, in the case of the support sleeve and the fibre core being directly mechanically connected, the refractive index of the support sleeve can be selected such that light guided in the fibre core is coupled out, into the support sleeve, via the direct connection. In the same way, in the case of the support sleeve being mechanically connected to the fibre core via the intermediate sleeve, the refractive indices of the support sleeve and intermediate sleeve can be selected such that light guided in the fibre core is coupled out, into the support sleeve, via the intermediate sleeve.

It is thereby possible for the radiation emerging in the region of the spliced ends to be diverted reliably outwards, without impairing the beam quality, and to prevent thermal damage, for example to the fibre sheath, resulting from the radiation emerging in the region of the spliced ends.

In the case of the method, the support sleeve can be realized as a volume scatterer and/or surface scatterer. The same applies to the intermediate sleeve(s). Further, in the case of the method, it is possible to use a single-piece support sleeve as the support sleeve.

In the case of the method according to the invention, an intermediate sleeve can be pushed over one of the two fibres before the splicing of the two fibres, which intermediate sleeve is mechanically connected to the fibre core of the first fibre after the splicing of the two fibres, wherein the support sleeve is then mechanically connected to the intermediate sleeve. Clearly, if a plurality of intermediate sleeves are provided, these are pushed onto one of the two fibres before the splicing of the two fibres and are connected to the corresponding fibre core before the connecting to the support sleeve, for its part. It is also possible, however, for the support sleeve to be first connected to the intermediate sleeve(s) and the intermediate sleeve(s) then to be connected to the fibre core(s).

The mechanical connection of the intermediate sleeve(s) to the fibre core(s) is preferably effected in a material-bonding and/or form-locking manner. In particular, the connection is produced through an input of heat. Laser radiation, in particular, can be used for this purpose.

It is understood that the features mentioned above and those yet to be explained in the following are applicable, not only in the stated combinations, but also in other combinations or singly, without departure from the scope of the present invention.

The invention is explained by way of example in yet greater detail in the following with reference to the attached drawings, which also disclose features essential to the invention. There are shown in:

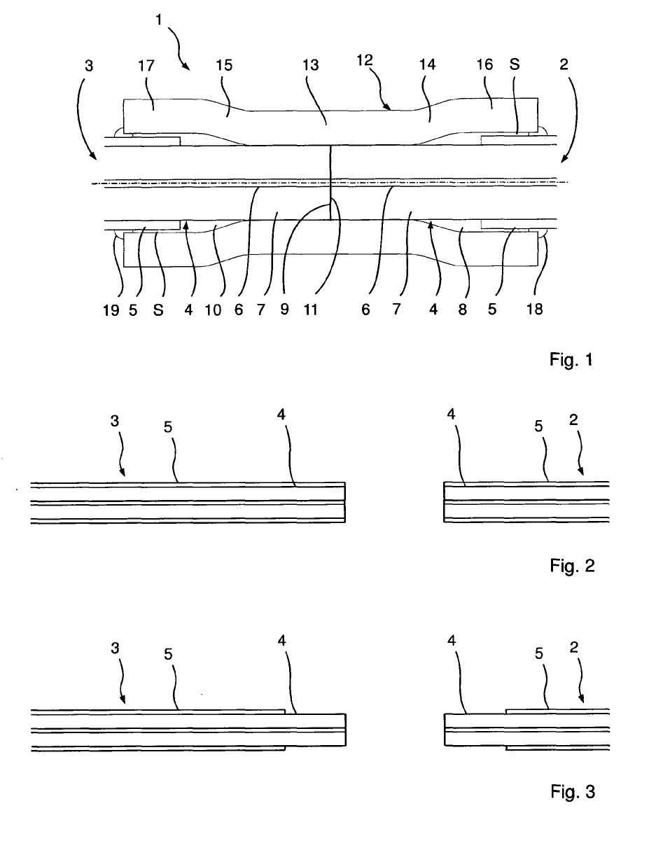

FIG. 1 a schematic sectional representation of a spliced joint according to the invention, according to a first embodiment;

FIGS. 2-6 sectional representations to explain the production of the spliced joint of FIG. 1;

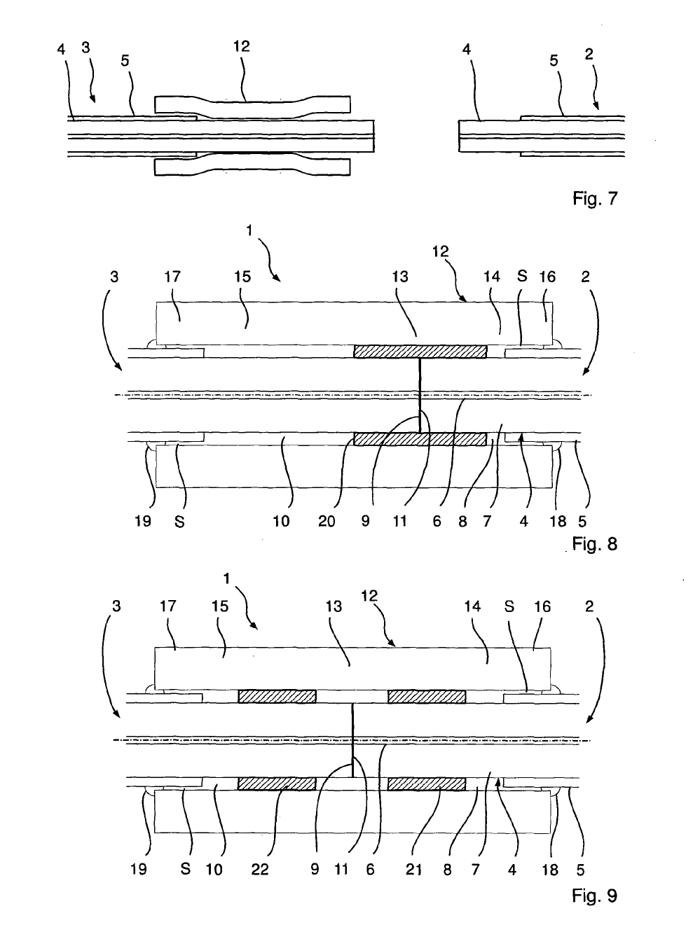

FIG. 7 a sectional representation to explain a modification of the production method;

FIG. 8 a schematic sectional representation of a spliced joint according to a further embodiment;

FIG. 9 a schematic representation of a spliced joint according to a further embodiment;

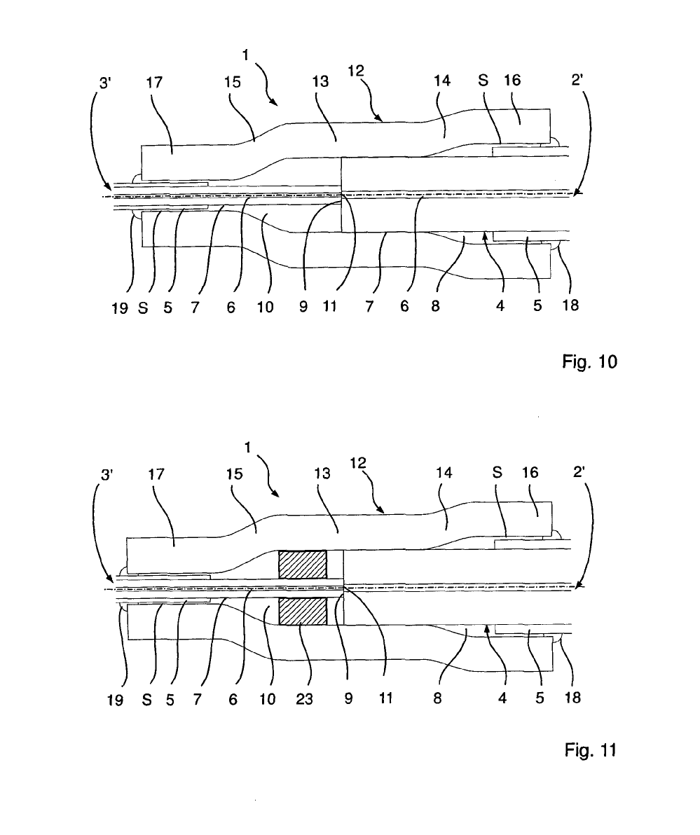

FIG. 10 a schematic representation of a spliced joint according to a further embodiment;

FIG. 11 a schematic representation of a spliced joint according to a further embodiment;

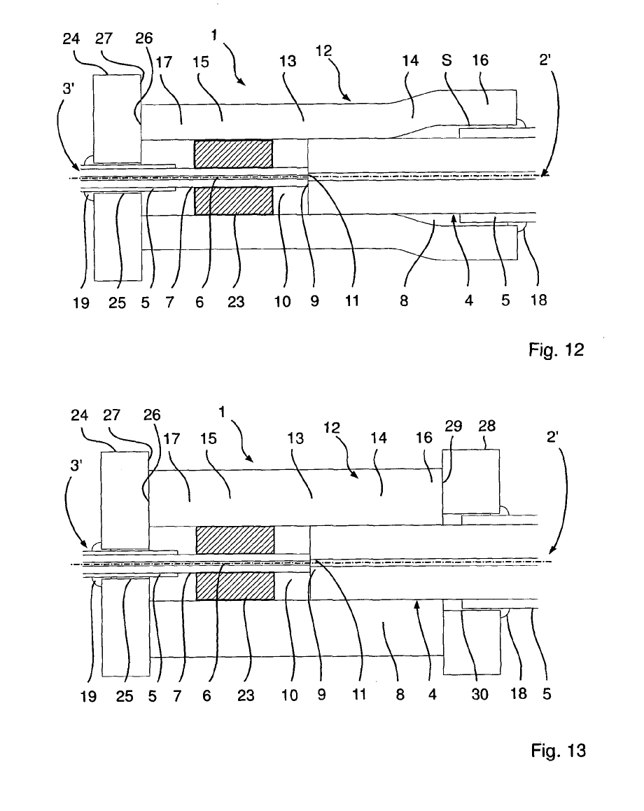

FIG. 12 a schematic representation of a spliced joint according to a further embodiment;

FIG. 13 a schematic representation of a spliced joint according to a further embodiment;

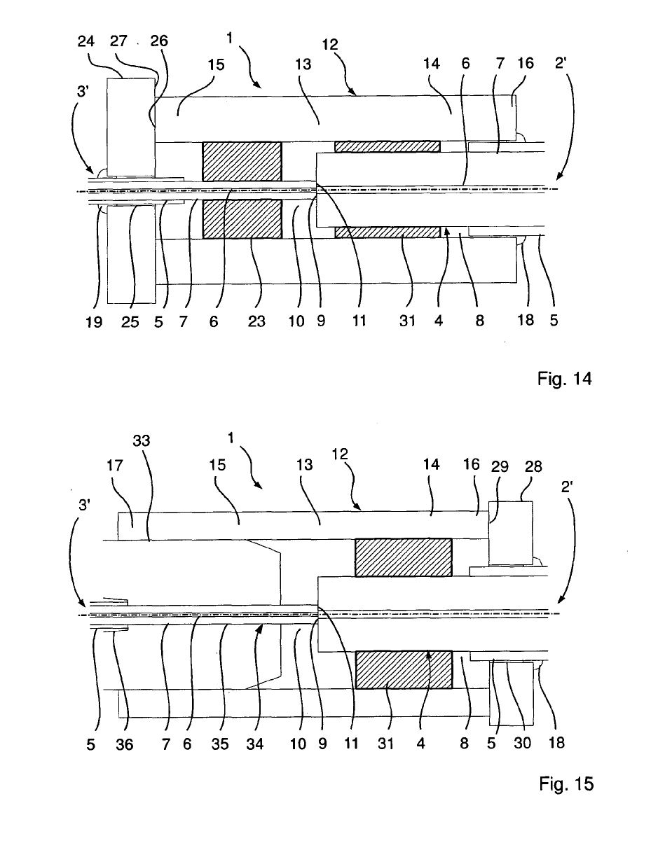

FIG. 14 a schematic representation of a spliced joint according to a further embodiment; and

FIG. 15 a schematic sectional representation of a spliced joint according to a further embodiment.

In the case of the embodiment shown in FIG. 1, the spliced joint 1 according to the invention comprises a first and a second optical fibre 2, 3, which are spliced to each other. Since the two fibres, or optical waveguides, 2, 3 have the same structure, only the first fibre 2 is described in detail in the following.

In order to enhance the clarity of the figures, the representation in FIG. 1 and in the figures yet to be described in the following is not true to scale. Further, in order to be able to achieve clear sectional representations, the hatchings normally used have been largely omitted from FIG. 1 and from the figures that follow.

The first fibre 2 has a fibre core 4 and a protective, or fibre, sheath 5 surrounding the fibre core 4. The fibre core 4 comprises an inner signal core 6, which is surrounded by a signal core sheath 7 (in the following, also referred to only as a sheath 7). The fibre core 4 is composed of quartz glass, which is doped differently for the signal core 6 and the sheath 7, such that, owing to the resultant step in the refractive index between the signal core 6 and the sheath 7, signal light can be guided in the signal core 6.

The fibre sheath 5 is realized as a polymer protective sheath 5, whose refractive index is selected such that, insofar as is desired, light can be guided in the sheath 7.

As can be seen from FIG. 1, the fibre sheath 5 is completely removed in a first connection region 8, which extends by a predetermined length (here, approximately 10 mm) from the spliced end 9 of the first fibre 2, along the longitudinal direction of the first fibre 2, such that the signal core sheath 7 is exposed in the first connection region 8. Further, it can be seen from FIG. 1 that, in a second connection region 10, which extends in the longitudinal direction along a predetermined length (here, again approximately 10 mm) from the spliced end 11 of the second fibre 3, is completely removed, such that, in the case of the second fibre 3 likewise, the signal core sheath 7 is fully exposed within the second connection region 10.

The spliced joint 1 additionally comprises a support sleeve 12, produced from quartz glass, which extends over both connection regions 8, 10, and laterally beyond each. The support sleeve 12 has a largely constant wall thickness of approximately 30-200 μm, but its inner diameter varies in the longitudinal direction. Thus, the support sleeve 12 has a central portion 13 having a first inner diameter that is adjoined on both sides, respectively, by a connection portion 14, 15 having an increasing inner diameter, which portions then graduate, respectively, into an edge portion 16, 17 having a constant inner diameter that is greater than the inner diameter of the central portion 13.

The central portion 13 is connected in a form-locking and material-bonding manner to the fibre cores 4, or to the signal core sheaths 7, of the two fibres 2, 3, whereas the two edge portions 16 and 17, which extend over the fibre sheaths 5, are at a distance from the latter, since the inner diameter of the edge portions 16 and 17 is selected such that it is (slightly) greater than the outer diameter of the fibre sheaths 5. There is thus a gap S between the edge portions 16, 17 and the respective fibre sheath 5. The inside of the edge portions 16, 17 therefore does not lie against the respective fibre sheath 5.

In order to protect the connection regions 8 and 10 from contamination, a ring 18, 19, which is composed of the same material as the fibre sheaths 5 and which seals off the gap S between the respective edge portion 16 and 17 and the fibre sheaths 5, is attached at both axial ends of the stiff, or rigid, support sleeve 12. Thus, with the exception of the rings 18, 19, there is no connection of the edge portions 16, 17 to the respective fibre sheath 5, and therefore to the corresponding fibres 2, 3.

The support sleeve 12, which can also be termed a support tube, is thus a waisted support sleeve 12, since the inner diameter of the central portion 13 is smaller than the inner diameter of the edge portions 16, 17.

Owing to the form-locking and material-bonding connection between the central portion 13 of the support sleeve 12 and the fibre cores 4 in the connection regions 8 and 10, the spliced joint 1 of the two fibres 2, 3 is mechanically stabilized and protected against unwanted bending or kinking. This protection against bending or kinking is further increased in that the two edge portions 16, 17 overlap the polymer protective sheaths 5.

The fibres 2, 3 shown in FIG. 1 are so-called single-core fibres. However, the fibres 2, 3 of FIG. 1 can also be realized as double-core fibres. In this case, the fibre core sheath 7 constitutes the so-called pump core 7, in which pump light is guided. For this purpose, the protective sheath 5 has, in particular, a refractive index such that the guiding of the pump light can be ensured.

The refractive index of the quartz glass from which the support sleeve 12 is produced is selected such that it is equal to or greater than the refractive index of the fibre core sheath 7 or of the pump core 7, to enable the radiation guided in the fibre core sheaths 7, or pump cores 7, of the fibres 2, 3 to be deliberately deflected out of the fibres 2, 3. The refractive index of the quartz glass of the support sleeve 12 can be constant or can vary spatially.

Further, the support sleeve 12 can be realized such that it has the property of a volume scatterer. This can be realized, for example, in that scattering particles are included in the quartz glass of the support sleeve 12. Additionally or alternatively, the outer support sleeve surface can have scattering properties (for example, in that it is roughened), such that the radiation deflected out of the fibres 2, 3 can be scattered, or radiated, in a distributed manner into the environment over a longer distance, and does not emerge with a high power density from the support sleeve end face.

In the case of the fibres 2, 3 shown in FIG. 1 being realized as double-core fibres, in which the radiation propagates not only within the inner signal core 6, but also within the pump core 7, in order to achieve a desired beam quality it is frequently necessary that, at the end of the entire fibre run, radiation emerges only from the inner signal core 6. In the case of the spliced joint 1 according to the invention, radiation from the pump core 7 can advantageously be deflected out of the fibres via the support sleeve 12, in the region of the spliced ends 9, 11, i.e. within the two connection regions 8, 10.

If the first fibre 2 is, for example, an active double-core fibre, the pump light not absorbed by the inner signal core 6 of the first fibre 2 during the propagation in the fibre core 4 can be advantageously deflected out of the fibre 2, in the region of the spliced ends 9, 10, at the end of the active double-core fibre 2, by means of the support sleeve 12 according to the invention, thereby preventing inadmissibly high thermal loading of the fibre run, or of the second fibre 3, after the active fibre 2.

Alternatively, the refractive index of the quartz glass of the support sleeve 12 can be selected such that it is less than the refractive index of the fibre core sheath 7 or of the pump core 7. As a result, in the region of the connection regions 8 and 10, the guiding of pump light in the pump cores 7, for example, is continued by the central portion 13, such that the spliced joint according to the invention enables the pump light to pass over, more or less without power loss, from the first fibre 2 to the second fibre 3. Preferably, the refractive index of the quartz glass of the support sleeve 12 is equal to or less than the refractive index of the polymer protective sheath 5.

The spliced joint 1 shown in FIG. 1 can be produced as follows. From the two ends of the fibres 2, 3 to be spliced (FIG. 2), which ends are each produced by, for example, breaking a fibre, the fibre sheath 5 of the respective fibre 2, 3 is in each case removed along the predetermined length. This can be performed, for example, by cutting by means of a laser (e.g. femtosecond laser), by etching or by scoring and breaking. The ends of the two fibres 2, 3 to be spliced are cleaned, polished or otherwise prepared, if necessary.

If desired, the exposed fibre cores can each be broken, or cut off, again and polished, if appropriate, in order to produce an end to be spliced that has the desired properties. This can be performed, for example, by cutting by means of a laser (e.g. femtosecond laser), or by scoring and breaking.

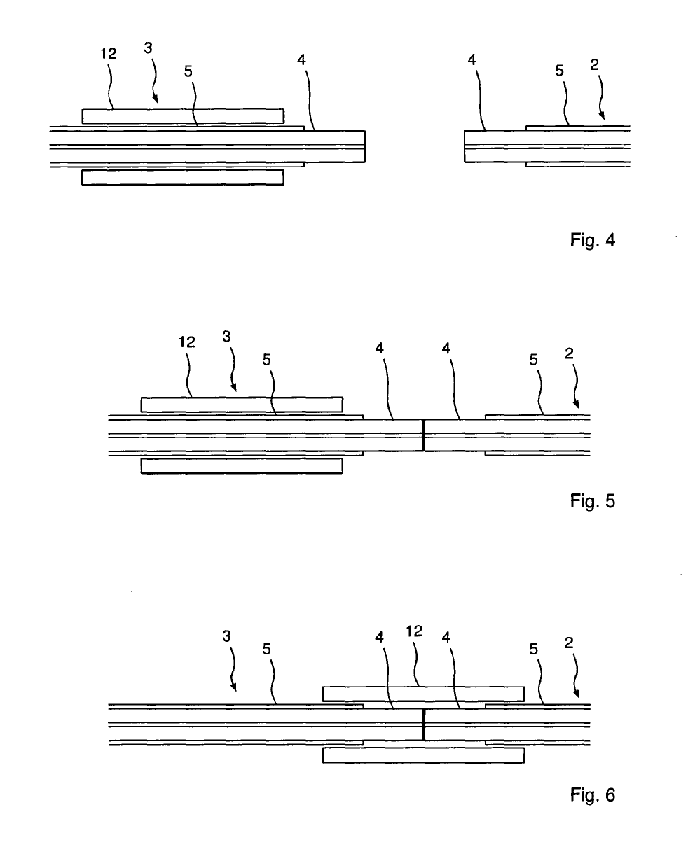

After the fibre cores 4 have been thus exposed (FIG. 3), the support sleeve 12 is pushed over one of the two fibres 2, 3. In the case of the embodiment example described here, it is pushed over the second fibre 3 to such an extent that it does not extend over the exposed fibre core 4, but is located entirely in the region of the fibre sheath 5 that is still present (FIG. 4).

The support sleeve 12 can also be pushed over the second fibre 3 before the fibre core 4 is exposed or after the fibre core 4 is exposed, but before the preparation of the end to be spliced.

The two free ends of the fibre cores are then aligned and spliced to each other in a known manner (FIG. 5).

After the splicing, the support sleeve 12 is pushed over the spliced ends 9, 11 such that it extends on both sides beyond the connection regions 8, 10 and thus overlaps the fibre sheaths 5 (FIG. 6). In this state, the central portion 13 of the support sleeve 12 is then shrunk (collapsed) onto the exposed fibre cores by a fusing process, such that a form-locking and material-bonding connection is produced. The connection portions 14, 15 and the edge portions 16, 17 in this case remain excluded from the fusing process, in order that there is no thermal damage to the polymer protective sheath 5.

The rings 18 and 19 are then realized and, if desired, the outer sheath surface of the support sleeve 12 is roughened, such that the spliced joint shown in FIG. 1 is obtained. Clearly, the outer sheath surface can also be roughened in an earlier step, or even before being pushed onto the second fibre 3.

In order to minimize the input of heat required in the collapsing of the central portion 13 onto the fibre cores 4, the support sleeve 12 can be already prepared to such an extent that the diameter changes required in the collapsing onto the fibre cores are minimal. In this case, it may be that the inner diameter of the central portion 13 is already less than the outer diameter of the fibre sheath 5 of the second fibre 3. If this is the case, the support sleeve 12 cannot be pushed fully over the fibre sheath 5, as shown in FIG. 4, but only partially, as indicated in FIG. 7. In other respects, the steps for producing the spliced joint correspond to the steps shown in FIGS. 2 to 6.

Shown in FIG. 8 is a second embodiment of the spliced joint 1 according to the invention, which differs from the embodiment shown in FIG. 1 in that the inner diameter of the support sleeve 12 is largely constant over its entire length. Further, a rigid, or stiff, intermediate sleeve 20 of quartz glass is provided, which is connected to the two fibre cores 4, in the region of the spliced ends 9, 11, in a form-locking and material-bonding manner. The support sleeve 12, for its part, is connected in a form-locking and material-bonding manner to the outer sheath surface of the intermediate sleeve 20. Thus, via the intermediate sleeve 20, there is a mechanical connection between the support sleeve 12 and the fibre cores 4. The edge portions 16, 17 of the support sleeve 12 that overlap the fibre sheaths 5 are at a distance from the fibre sheaths 5, in the same manner as in the case of the embodiment of FIG. 1.

In the sectional representation of FIG. 8, in order to simplify the representation only the intermediate sleeve 20 is represented by hatching. Likewise, in the description of the following embodiment examples, only the intermediate sleeves are represented by hatching, in order to simplify the representation.

Clearly, in the production of the spliced joint of FIG. 8, both the intermediate sleeve 20 and the support sleeve 12 are pushed over one of the two fibres 2, 3 before the two fibres 2, 3 are spliced. In this case, both sleeves 12, 20 can be pushed over the same fibre 2, 3, or the intermediate sleeve 20 can be pushed over one of the two fibres 2, 3 and the support sleeve over the other of the two fibres 2, 3.

After the splicing of the two fibres 2, 3, the intermediate sleeve 20 is then first brought into the position shown in FIG. 8 and collapsed onto the fibre cores 4. The support sleeve 12 is then brought into the position shown in FIG. 8 and collapsed onto the intermediate sleeve.

FIG. 9 shows a modification of the spliced joint shown in FIG. 8. Unlike the spliced joint of FIG. 8, in the case of FIG. 9 two intermediate sleeves 21, 22 are provided, wherein respectively one of the intermediate sleeves 21 and 22 is located in respectively one of the two connection regions 8 and 10. Apart from their geometric dimensions, the intermediate sleeves 21 and 22 are realized in the same manner as the intermediate sleeve 20 and, again, are connected to the corresponding fibre cores 4 in a form-locking and material-bonding manner. The support sleeve 12 is connected to the two intermediate sleeves 21 and 22 in a form-locking and material-bonding manner. In the case of this embodiment, likewise, as in the case of the embodiments that follow, the intermediate sleeves are first connected to the fibre cores, and the support sleeve is then connected to the intermediate sleeves.

Shown in FIG. 10 is an embodiment example in which two fibres 2′, 3′ having greatly differing diameters are spliced to each other. The fibres 2′ and 3′ are constructed in basically the same manner as the fibres 2 and 3 of the embodiment examples described in connection with FIGS. 1 to 9.

In the case of the embodiment example of FIG. 10, the support sleeve 12 tapers in a stepped manner from the thicker fibre 2′ towards the thinner fibre 3′. Thus, in this embodiment example, the two edge portions 16 and 17 of the support sleeve 12 have differing inner diameters, which are adapted to the respective outer diameters of the two fibres 2′ and 3′. In the case of this embodiment example, likewise, the inner diameter of the respective edge portion 16, 17 is always (somewhat) greater than the respective outer diameter of the fibre sheaths 5 of the corresponding fibres 2′, 3′.

Further, the support sleeve 12, in the central portion 13, is connected to the fibre core sheath 7, or to the pump core 7, of the fibre 2′ in a form-locking and material-bonding manner. In the case of the realization as a pump core 7, the desired coupling-out of the pump light can thus, for example, be ensured.

Shown in FIG. 11 is a modification of the embodiment of FIG. 10, which differs only in that an intermediate sleeve 23, which is connected to the fibre core 4 of the fibre 2′ in a form-locking and material-bonding manner, is disposed between the central portion 13 of the support sleeve 12, in the second connection region 10, and the fibre 3′. Apart from its geometric dimensions, the intermediate sleeve 23 is realized in the same manner as the intermediate sleeve 20. The central portion 13 of the support sleeve 12, for its part, is again connected to the intermediate sleeve 23 in a form-locking and material-bonding manner.

Shown in FIG. 12 is a modification of the embodiment of FIG. 11, in which the central portion 13, as well as the connection portion 15 and the edge portion 17, have the same inner diameter. Further provided is a support disc 24, which has a central bore 25 having an inner diameter that is greater than the outer diameter of the fibre sheath 5 of the fibre 3′. Furthermore, the support disc 24 has an outer diameter such that the left end face 26 of the support sleeve 12 bears against the inside 27 of the support disc 24 that faces towards the support sleeve 12. The end face 26 is connected to the inside 27 in a form-locking and material-bonding manner. Owing to the constant inner diameter of the central portion 13, the connection portion 15 and the edge portion 17, the axial length of the intermediate sleeve 23 can be selected so as to be greater than is possible in the embodiment of FIG. 11.

Because of the material-bonding connection of the support sleeve 12 and the support disc 24, they together constitute a two-part support sleeve.

In the case of the modification of the spliced joint of FIG. 12 that is shown in FIG. 13, a second support disc 28 is provided, which is connected to the right end face 29 of the support sleeve 12 in a form-locking and material-bonding manner, wherein the second support disc 28 has a central bore 30 whose inner diameter is somewhat greater than the outer diameter of the fibre sheath 5 of the fibre 2′. In the case of this embodiment, the support sleeve 12 can thus have a constant inner diameter over its entire length. In comparison with FIG. 12, it can thus be connected over a greater length to the fibre core 4 of the first fibre 2′ in a form-locking and material-bonding manner. The support sleeve 12 and the two support discs 24 and 28 together constitute a three-part support sleeve.

A further modification of the embodiment of FIG. 12 is shown in FIG. 14. In the case of this modification, the support sleeve 12 again has a constant inner diameter over its entire length. The inner diameter in this case is selected such that it is somewhat greater than the outer diameter of the fibre sheath 5 of the fibre 2′. For the purpose of connecting the support sleeve 12 to the fibre core 4 of the fibre 2′, a further intermediate sleeve 31 is provided, which is connected to the fibre core 4 of the first fibre 2′ in a form-locking and material-bonding manner. Apart from its geometric dimensions, the intermediate sleeve 31 is realized in the same manner as the intermediate sleeve 20. The support sleeve 12 is connected respectively to the intermediate sleeve 31 and to the intermediate sleeve 23 in a form-locking and material-bonding manner.

Shown in FIG. 15 is a design of the spliced joint according to the invention in which the support sleeve 12 again has a constant inner diameter over its entire length. The right end face 29 of the support sleeve 12 is connected in a form-locking and material-bonding manner to a support disc 32, which can be realized in the same manner as the second support disc 28 according to FIG. 13. The second fibre 3′ is guided in a ferrule 33 (core end sleeve for optical fibres), wherein the ferrule 33 has a stepped central bore 34, which, from its right end, has a first portion 35 having a constant first inner diameter that corresponds to the outer diameter of the fibre core 7 of the second fibre 3′, and a second portion 36, which adjoins the first portion and which has an abruptly greater second inner diameter that additionally increases towards the left and that is at least somewhat greater than the outer diameter of the fibre sheath 5 of the second fibre 2′. The outer diameter of the ferrule 33 is selected such that the support sleeve 12 can be connected to the ferrule 33 in a form-locking and material-bonding manner.

Further provided is an intermediate sleeve 31, which, apart from its geometric dimension, corresponds to the intermediate sleeve of FIG. 14. The intermediate sleeve 31 is connected to the fibre core 4 of the first fibre 2′ in a form-locking and material-bonding manner, and the support sleeve 12 is connected to the intermediate sleeve 31 in a form-locking and material-bonding manner.

The support discs 24 and 28 shown in FIGS. 12-15 are preferably produced from the same material as the support sleeve 12. The same applies to the ferrule 33.

1-26. (canceled)

27. A spliced joint between a first optical fibre and a second optical fibre, each having a spliced end, comprising:
each of the first and second optical fibres including a fibre core and a fibre sheath that lies against the latter, the fibre sheath of at least one of the first and second optical fibres being completely removed in a connection region that extends along a predetermined length from the spliced end of the respective fibre, in the longitudinal direction of the fibre; and
a support sleeve in which the spliced ends of the first and second two fibres are disposed and which extends at least along the entire connection region of the first fibre and therebeyond, over the fibre sheath of the first fibre,
wherein a portion of the support sleeve extends over the fibre sheath of the first fibre that does not lie against the fibre sheath of the first fibre and, in the connection region of the first fibre, is mechanically connected to the fibre core of the first fibre, either directly or via an intermediate sleeve.

28. A spliced joint according to claim 27, wherein the mechanical connection between the support sleeve and the intermediate sleeve or fibre core is a form-locking connection.

29. A spliced joint according to claim 27, wherein the mechanical connection between the support sleeve and the intermediate sleeve or fibre core is a material-bonding connection.

30. A spliced joint according to claim 27, wherein the portion of the support sleeve that extends over the fibre sheath of the first fibre, apart from a possibly provided end-face sealing, is not mechanically connected to the fibre sheath.

31. A spliced joint according to claim 27, wherein, in the region of the mechanical connection, the inner diameter of the support sleeve is less than in the case of the portion that extends over the fibre sheath of the first fibre.

32. A spliced joint according to claim 27, wherein the fibre sheath is completely removed in the respective connection region of both first and second fibres, wherein the support sleeve extends along the entire connection region of the second fibre and therebeyond, over the fibre sheath of the second fibre, and wherein the portion of the support sleeve that extends over the fibre sheath of the second fibre does not lie against the fibre sheath of the second fibre.

33. A spliced joint according to claim 32, wherein, in the connection region of the second fibre, the support sleeve is mechanically connected to the fibre core of the second fibre, either directly or via an intermediate sleeve.

34. A spliced joint according to claim 32, wherein the portion of the support sleeve that extends over the fibre sheath of the second fibre, apart from an end-face sealing, is not mechanically connected to the fibre sheath.

35. A spliced joint according to claim 27, wherein, in the case of the support sleeve and the fibre core being directly mechanically connected, the refractive index of the support sleeve is selected such that light guided in the fibre core can be coupled out, into the support sleeve, via the direct connection.

36. A spliced joint according to claim 27, wherein, in the case of the support sleeve being mechanically connected to the fibre core via the intermediate sleeve, the refractive indices of the support sleeve and intermediate sleeve are selected such that light guided in the fibre core can be coupled out, into the support sleeve, via the intermediate sleeve.

37. A spliced joint according to claim 27, wherein at least one of the support sleeve and the intermediate sleeve comprises a volume scatterer.

38. A spliced joint according to claim 27, wherein the support sleeve comprises a surface scatterer.

39. A spliced joint according to claim 27, wherein the support sleeve comprises a single piece.

40. A method for producing a spliced joint between a first optical fibre and a second optical fibre, each of which having an end, a fibre core and a fibre sheath that lies against the latter, the method comprising:
completely removing from at least one of the first and second fibres the fibre sheath in a connection region that extends along a predetermined length from the end of the respective fibre that is to be spliced, in the longitudinal direction of the fibre;
pushing a support sleeve over one of the first or second fibres;
aligning and splicing to each other the ends of the fibres that are to be spliced;
pushing the support sleeve over the spliced ends such that the spliced ends of the two fibres are disposed in the support sleeve, and the support sleeve extends at least along the entire connection region of the first fibre and therebeyond, over the fibre sheath of the first fibre, without the portion of the support sleeve that extends over the fibre sheath of the first fibre lying against the fibre sheath of the first fibre; and
mechanically connecting, in the connection region of the first fibre, the support sleeve to the fibre core of the first fibre, either directly or via an intermediate sleeve.

41. A method according to claim 40, wherein the mechanical connection between the support sleeve and the intermediate sleeve or fibre core is realized as a form-locking connection.

42. A method according to claim 40, wherein the mechanical connection between the support sleeve and the intermediate sleeve or fibre core is realized as a material-bonding connection.

43. A method according to claim 40, wherein the portion of the support sleeve that extends over the fibre sheath of the first fibre, apart from a an end-face sealing, is not mechanically connected to the fibre sheath.

44. A method according to claim 40, wherein the fibre sheath is completely removed in the respective connection region in the case of both fibres, and the support sleeve is pushed over the spliced ends such that it extends along the entire connection region of the second fibre and therebeyond, over the fibre sheath of the second fibre, without the portion of the support sleeve that extends over the fibre sheath of the second fibre lying against the fibre sheath of the second fibre.

45. A method according to claim 44, wherein, in the connection region of the second fibre, the support sleeve is mechanically connected to the fibre core of the second fibre, either directly or via an intermediate sleeve.

46. A method according to claim 44, wherein the portion of the support sleeve that extends over the fibre sheath of the second fibre, apart from an end-face sealing, is not mechanically connected to the fibre sheath.

47. A method according to claim 40, wherein, in the case of the support sleeve and the fibre core being directly mechanically connected, the refractive index of the support sleeve is selected such that light guided in the fibre core can be coupled out, into the support sleeve, via the direct connection.

48. A method according to claim 40, wherein, in the case of the support sleeve being mechanically connected to the fibre core via the intermediate sleeve, the refractive indices of the support sleeve and intermediate sleeve are selected such that light guided in the fibre core can be coupled out, into the support sleeve, via the intermediate sleeve.

49. A method according to claim 40, wherein the support sleeve comprises a volume scatterer and/or surface scatterer is used as the support sleeve.

50. A method according to claim 40, wherein the support sleeve comprises a single-piece sleeve.

51. A method according to claim 40, wherein the intermediate sleeve comprises a volume scatterer.

52. A method according to claim 40, wherein the intermediate sleeve is pushed over one of the two fibres before the splicing of the two fibres, which intermediate sleeve is mechanically connected to the fibre core of the first fibre after the splicing of the two fibres, wherein the support sleeve is then mechanically connected to the intermediate sleeve.
